(19) United States
(12) Patent Application Publication
(10) Pub. No.: US 2005/0229104 A1
(43) Pub. Date: Oct. 13, 2005

(54) Add-on management

(75) Inventors: Roberto A. Franco, Seattle, WA (US); Quji Guo, Stanford, CA (US); Roman Pamucci, Bellevue, WA (US); Christopher T. Sager, Bellevue, WA (US); Reid T. Holmes, Nanaimo (CA); J. Craig Hally, Sammamish, WA (US); Joseph Benedek, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/822,221

(22) Filed: Apr. 9, 2004

(51) Int. Cl. G06F 17/00

(52) U.S. Cl. 715/743; 715/749

(57) ABSTRACT

The present invention provides a method and a computer-readable medium containing computer-executable instructions for allowing a user of an application program to manage add-ons associated with the application program. A user interface that displays the add-ons associated with the application program is provided. The user interface provides the user with the ability to disable or enable the add-ons, the ability to update certain type of add-ons. In addition, an administrator of the application program can approve or deny certain add-ons and disable a user's ability to disable or enable add-ons.

### FIELD OF THE INVENTION

The present invention relates to computer programs and, in particular, to a computer program that supports add-on controls.

### BACKGROUND OF THE INVENTION

Since its conception in the ARPANET project in the late 1960s, the Internet has become an integrated part of contemporary living. Web browsers allow Internet users to obtain fast, easy, hypertext access to information on computers located all over the world. A Web browser is a software platform that allows an Internet user to view documents and to access files and software related to those documents. Early Web browsers—such as NCSA Mosaic® and the early versions of Netscape Navigator®—provided basic functions that allow users to point and click with a mouse to browse documents, download and transfer files, etc.

The appearance of plug-in technology in the 1990s greatly expanded and enhanced these basic functions of Web browsers. Plug-in technology enables a small software program to be plugged into a larger application to provide added functionalities. These small software programs are called “add-on controls,” or simply “add-ons.” More specifically, in the Web context, the plug-in technology enables add-ons, such as ActiveX® controls, browser helper objects, and toolbar extensions, to run from a Web browser and to act as part of the Web browser. A Web browser's functionality can thus be arbitrarily expanded. For example, with the help of add-ons, a Web browser can access and execute files embedded in the Web page that are in formats the browser normally would not recognize, such as animation, video, and audio files.

FIG. 1A illustrates a Web Browser 102 hosting a Web page 104. The Web page 104 uses an ActiveX® control 106, which is one kind of add-on. An ActiveX® control 106 is a reusable software component based on Microsoft's ActiveX® technology that is used to add interactivity and more functionalities to a Web page, applications, and software development tools. An ActiveX® control 106 is an integrated part of the Web page 104 where the ActiveX® control 106 is invoked. A creator of an ActiveX® control 106 may put a new version 108 of the ActiveX® control 106 on the Internet 110. A Web browser 102 can update 112 the Active X® control 106 by getting the new version 108 of ActiveX® control 106 from Internet 110 directly or through a network 114.

An add-on can also be a browser helper object 116. A browser helper object 116 is intended to be launched by a Web browser 102 after the Web browser 102 downloads a file that the Web browser 102 is not able to process itself. Examples of browser helper objects are sound and movie players. Unlike ActiveX® controls 106, browser help objects 114 are not part of a Web page 104; they are an integral part of a Web browser 102 that hosts a Web page 104.

Add-ons greatly enhance application program extensibility in terms of an application program's functionalities, if the add-ons function properly. However, if add-ons are not properly designed for, or installed incorrectly in, an application program, they may disrupt the application program's normal operation and cause the application program to crash. For example, according to a study, 68% of Microsoft Internet Explorer® crashes originate from third party add-ons. Third-party add-ons for a Web browser usually are automatically installed while a user surfs the Internet, and their existence is invisible to an Internet user. A user usually does not know that an add-on is the cause of a Web browser crash. Some users mistakenly believe that the Web browser itself caused the crash and continue to use the defective add-ons. As a result, a user using the Web browser continues to experience browser instability. Because the user does not know the cause of a crash and is unable to prevent further crashes, the usability of the Web browser is reduced.

FIG. 1B illustrates an example of a current approach in handling browser crashes that may have been caused by add-ons. When a browser crash occurs, the Web browser 152 displays a notification window 154, informing the user that the Web browser 152 encountered a problem and will be closed. The Web browser 152 allows the user to debug the problem by selecting a debug button 156 in the notification window 154. The Web browser 152 may also prepare an error report about the crash and gives the user an option to send the error report to the Web browser vendor by selecting a send error report button 158 in the notification window 154. When receiving such crash reports from users, the Web browser vendor identifies the cause of crashes. If an add-on is the cause of the failure, the Web browser vendor may either provide an update that disables the add-on or request an update from the third party that created the add-on (publisher of the add-on).

Hence, current application programs give users no ability to manage the add-ons that are associated with the application programs. More specifically, users cannot observe what add-ons are running in association with an application program. Neither can users disable or enable any add-ons according to user preferences. Nor can users update an add-on themselves.

Accordingly, in light of the above problems, there is a need for an application program that allows users to observe what add-ons are available for use or are hosted by the application program. There is also a need for an application program that allows a user to manage add-ons, i.e., enable, disable, or update these add-ons according to a user's preference. The present invention is directed to addressing these needs for application programs that support add-ons.

### SUMMARY OF THE INVENTION

The present invention addresses the above-identified needs by providing a method and a computer-readable medium containing computer-executable instructions that allow a user of an application program to manage add-ons associated with the application program.

In one aspect of the present invention, the method allows a user of an application program to observe add-ons associated with the application program. Preferably the method also provides the user with the ability to enable or disable add-ons. Further, preferably, the method allows the user to update certain add-ons, such as ActiveX® controls.

In accordance with other aspects of the present invention, the method allows an administrator of an application program to approve or block particular add-ons for the application program. Preferably, the administrator can also restrict a user's ability to disable or enable add-ons.

As will be readily appreciated from the foregoing summary, the present invention gives a user the ability to observe and manage add-ons associated with an application program. The present invention improves the stability of an application program that supports add-ons by allowing a user to disable a problematic add-on.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a block diagram illustrating one embodiment of an application program, such as a Web browser, using add-ons;

FIG. 1B is an example of a notification window employed in a current approach to handle Web browser crashes that may have been caused by add-ons;

FIG. 2A is an example of a notification window employed in a Web browser embodiment of the present invention;

FIG. 2B is an example of a notification window employed in another Web browser embodiment of the present invention;

FIG. 2C is an example of yet another Web browser embodiment of the present invention;

FIG. 3A illustrates an example of a manage add-ons program window suitable for use in embodiments of the present invention;

FIGS. 3B-3D are examples of notification messages illustrating the feedback that a manage add-ons program sends to users;

FIG. 4 is a functional flow diagram illustrating an exemplary embodiment of the present invention in a crash management setting;

FIGS. 5A-5B are functional flow diagrams illustrating an exemplary embodiment of the present invention when a user encounters a Web page containing a disabled add-on; and

FIGS. 6A-6C are functional flow diagrams illustrating an exemplary embodiment of a manage add-ons program suitable for use in FIGS. 4 and 5A-5B.

### DETAILED DESCRIPTION OF THE PREFERRED EMBODIMENT

The present invention is generally directed to improving the stability of an application program that uses add-ons by allowing a user of the application program to observe and manage add-ons available to an application program.

Although the present invention will be described in the context of a Web browser program, those skilled in the relevant art and others will appreciate that the present invention is also applicable to other application programs that can use add-ons. Further, the illustrative examples provided herein are not intended to be exhaustive or to limit the invention to the precise forms disclosed. Similarly, any steps described herein may be interchangeable with other steps, or several combinations of steps, in order to achieve the same result. Accordingly, the described embodiments of the present invention should be construed as illustrative in nature and not as limiting.

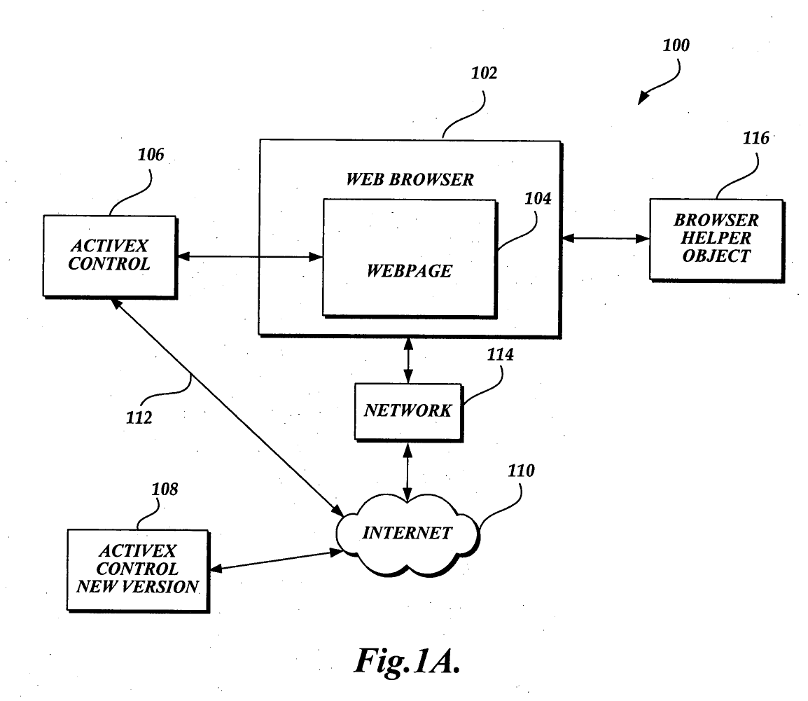

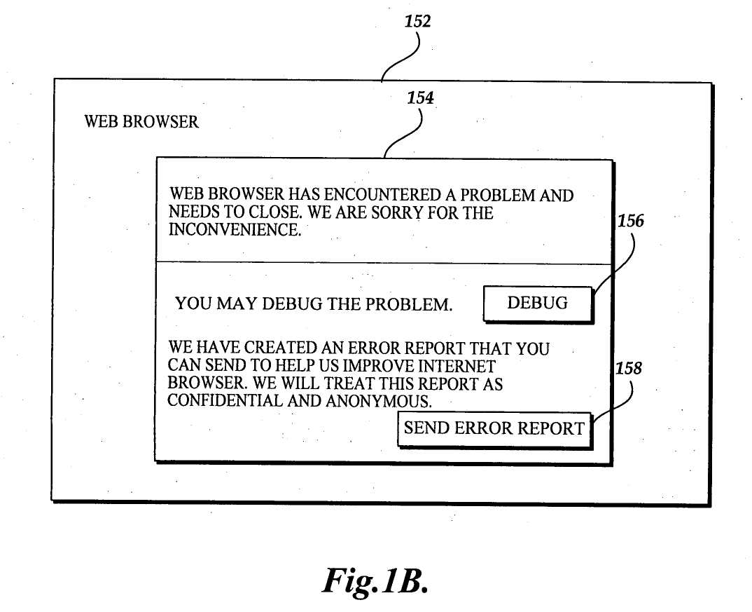

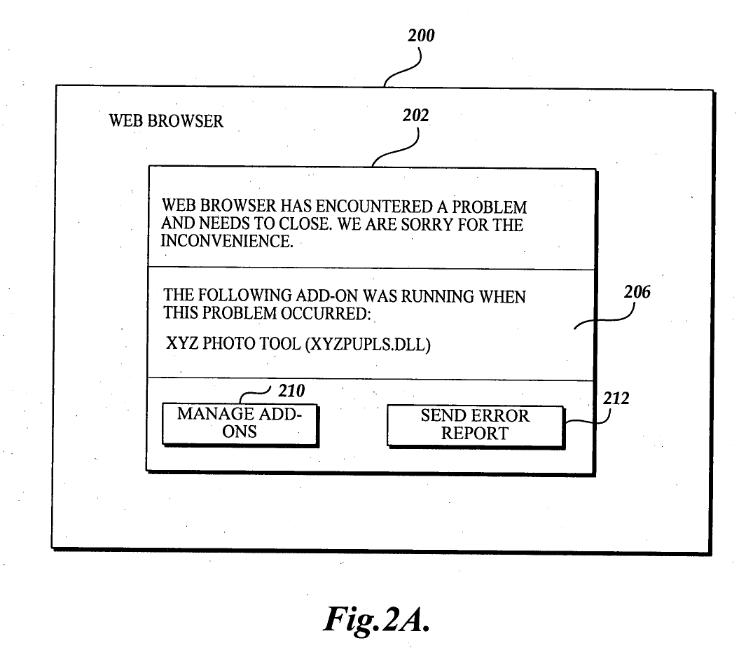

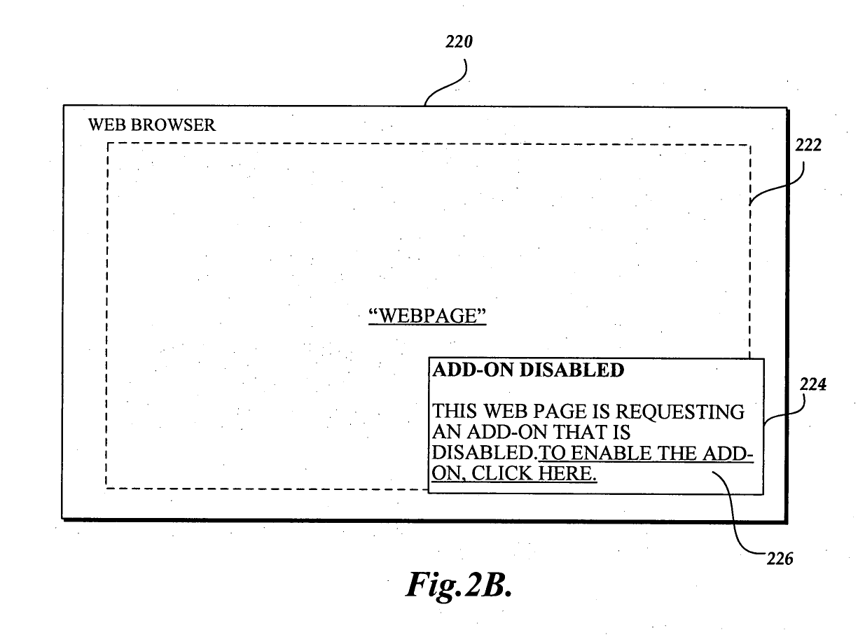

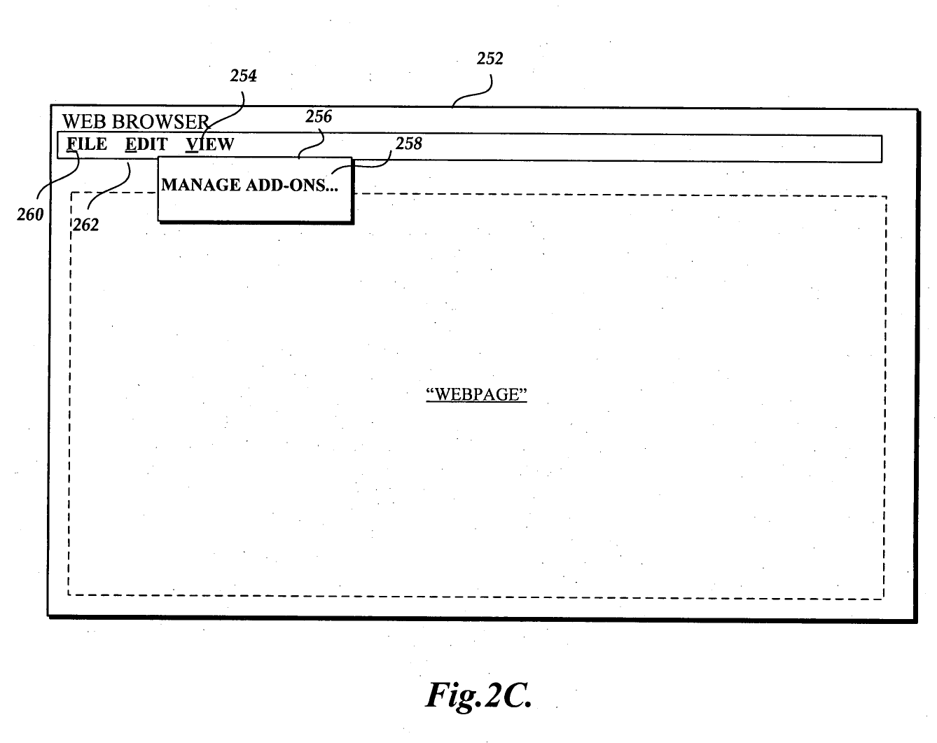

FIG. 2A illustrates one aspect of the present invention. Upon a user experiencing a problem in the normal function of a Web browser 200, the Web browser 200 decides that an add-on may have caused the problem. The Web browser 200 then displays a notification window 202 informing the user that the browser has encountered a problem with an add-on and needs to close. The notification window 202 further identifies to the user the add-on 206 that may have caused the problem. The notification message 202 further allows the user to manage the add-ons available to the Web browser 200 by providing a “manage add-ons” 210 button. This button enables a manage add-ons program upon being actuated. In one exemplary embodiment, upon a user opening the manage add-ons program from a Web browser that experienced a problem caused by an add-on, the default view of the program user interface shows a list of all enabled add-ons associated with the Web page where the problem occurred, with the add-on 206 that may have caused the problem positioned at the top of the list. The notification window 202 also gives the user the option to report the problem to the Web browser vendor by clicking on a “send error report” button 212. If the problem the user experienced is not caused by an add-on, the Web browser displays a notification window 152 of the type illustrated in FIG. 1B, which allows the user to debug the problem and/or report the problem to the Web browser vendor.

FIG. 2B illustrates another way in which a manage add-ons program may be employed by a Web browser 220. When a user navigates to a Web page 222 that requests a disabled add-on, the Web browser 220 will display a notification window 224 to inform the user that the Web page 222 is requesting a disabled add-on. This notification window 224 also provides a hypertext link 226 that, when clicked, enables the manage add-ons program to allow the user to enable the disabled add-on.

FIG. 2C shows another approach of employing a manage add-ons program by a Web browser. In FIG. 2C, the manage add-ons program 258 is launched from a menu item or tool bar of a Web page 252. For example, a user of Web browser can invoke the manage add-ons program 258 from a drop-down panel 256 associated with the menu item “view” 254. Alternatively, the manage add-ons program can also be positioned in and invoked from other menu items, such as “file” 260 or “edit” 262.

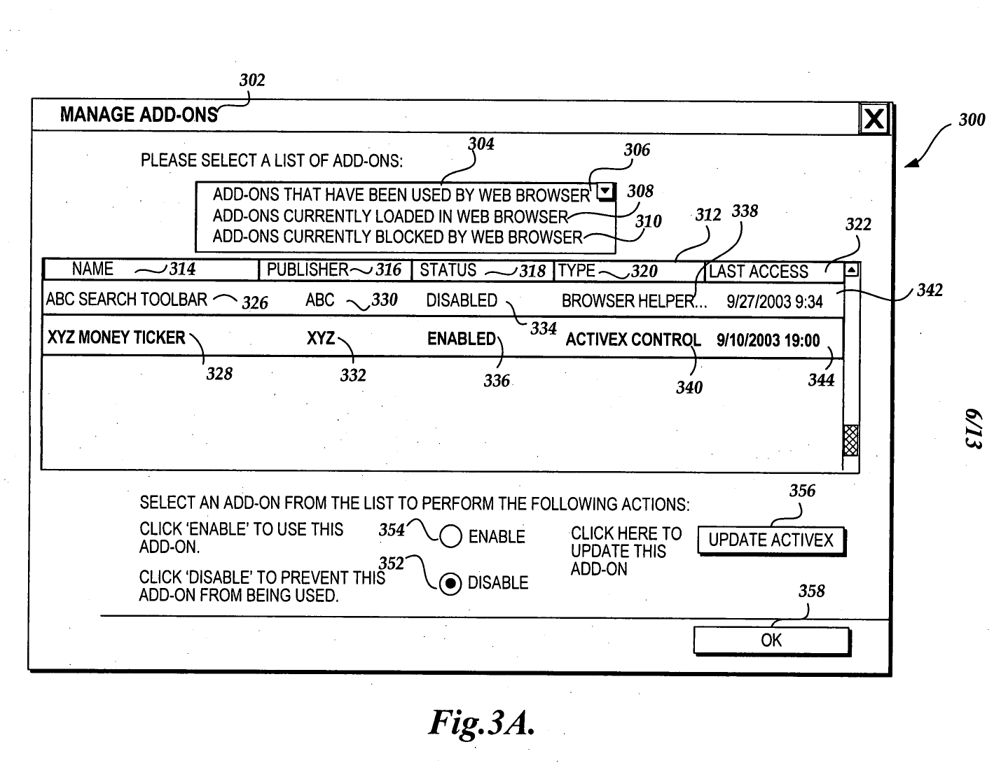

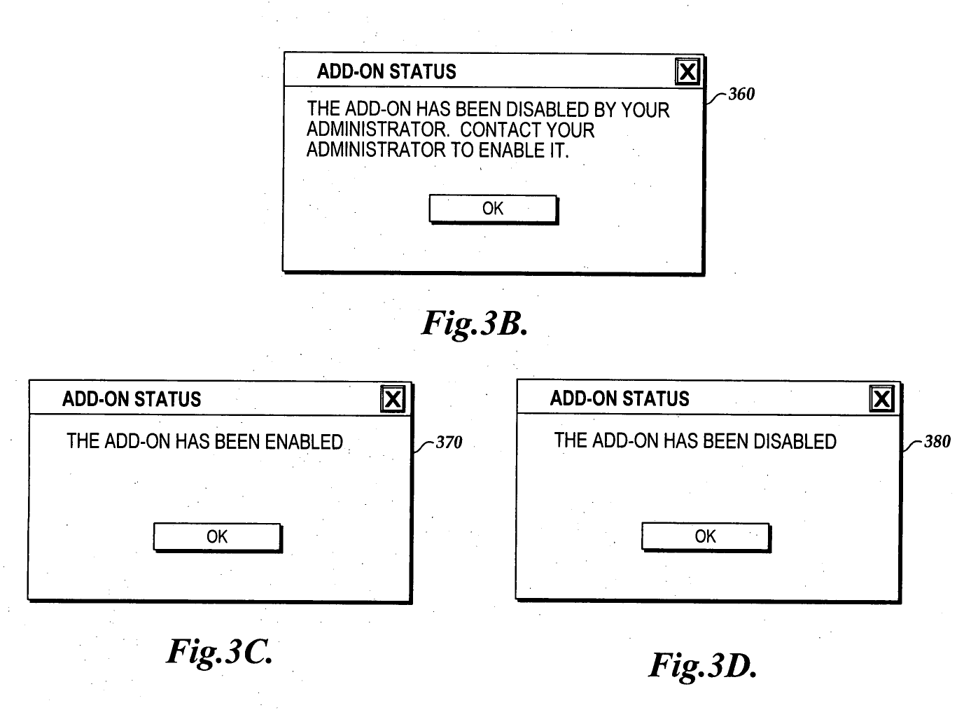

FIG. 3A illustrates an example of a manage add-ons program user interface 300. The user interface 300 includes a manage add-ons title 302. The user interface 300 allows, a user to select a list of add-ons that the user wants to view. More specifically, the manage add-ons program maintains in a drop-box 304 multiple lists of add-ons, such as a list of add-ons that have been used by the Web browser 306, a list of add-ons currently loaded in the Web browser 308, and a list of add-ons that are currently blocked by the Web browser 310. After a user has selected one of the lists from the drop-down box 304, the manage add-ons program causes the user interface 300 to display the add-ons contained in the selected list on a display panel 312.

The display panel 312 shows the names 314 of add-ons contained in the selected list. For example, the display panel 312 in FIG. 3A displays two add-ons—namely, ABC Search Toolbar 326 and XYZ Money Ticker 328. The display panel 312 also shows the publisher 316 of an add-on. A publisher of an add-on is generally the creator of the add-on. For example, the add-on ABC Search Toolbar 326 is created by ABC 330, and the add-on XYZ Money Ticker 328 is shown to be created by XYZ 332. In some application programs, such as Microsoft Internet Explorer®, users are able to block add-ons from particular publishers. The display panel 312 also displays the status 318 of each listed add-on, i.e., whether the add-on is disabled or enabled. For example, the add-on ABC Search Toolbar 326 is shown to be disabled 334 and the add-on XYZ Money Ticker 328 is shown to be enabled 336. Further, the display panel 312 includes the type 320 of each listed add-on. For example, the add-on ABC Search Toolbar 326 is identified as a browser helper object 338, while the add-on XYZ Money Ticker 328 is identified an ActiveX® control 340. Finally, the display panel 312 identifies when each listed add-on is lastly accessed 322. In this example, the ABC Search Toolbar 326 add-on was lastly accessed 342 at 9/27/2003 9:34, while the XYZ Money Ticker® 328 add-on was lastly accessed 344 at 9/10/2003 19:00.

In one embodiment of the present invention, if at least one of the add-ons in the display panel 312 is disabled, the display panel 312 is divided into two sections. One section shows enabled add-ons and the other section shows disabled add-ons.

Users can select any add-on in a list displayed in the display panel 312 by clicking on the add-on. This causes the selected add-on to be highlighted in some fashion well known by those skilled in the art.

After a user has selected an add-on in the display panel 312, the manage add-ons program user interface 300 allows the user to select either a disable button 352 to prevent the add-on from being used by the associated application program, in this case a Web browser, or enable button 354 to enable an add-on that has been disabled. In one embodiment of the present invention, a user can enable or disable multiple add-ons at the same time. For example, a user can first select multiple add-ons by holding down both the control key and the shift key on the keyboard while clicking on multiple add-ons in the display panel 312. The user can then enable or disable the selected multiple add-ons by clicking either the enable button 354 or the disable button 352 only once.

In addition, if the selected add-on is an ActiveX® control, a user may also update the add-on by selecting an “update ActiveX®” button 356. The update functionality does not necessarily work for all add-ons that appear in the display panel 312. For example, certain browser helper objects can not be updated this way. In one embodiment of the present invention, if an add-on that cannot be updated is selected, the “update ActiveX®” button 356 appears disabled.

When the user selects an OK button 358, the manage add-ons program proceeds to apply any configuration changes entered by the user.

After the manage add-ons program successfully executes a user's request to enable an add-on, the status of the add-on is updated accordingly. If desired, notification message 370, informing the user that the add-on has been enabled, may be displayed. See FIG. 3C.

Similarly, once the manage add-ons program successfully executes a user's request to disable an add-on, the status of the add-on is updated accordingly. If desired, notification message 380, informing the user that the add-on has been disabled may be displayed. See FIG. 3D.

Further, Embodiments of the present invention allow administrators of application programs using add-ons to administer the add-ons. In one exemplary embodiment, an administrator may provide an explicit list of denied add-ons. The manage add-on program user interface 300 displays these add-ons through the list of add-ons that are currently blocked by the Web Browser 310, as shown in FIG. 3A. These denied add-ons are also called restricted add-ons. A user cannot enable or instantiate a restricted add-on. When a user attempts to enable a restricted add-on through the manage add-ons program, the manage add-ons program displays a notification window 360 telling the user that this particular add-on has been disabled by the administrator and suggesting the user contract the administrator to enable the add-on. See FIG. 3B.

Embodiments of the present invention also allow administrators of application programs to provide an explicit list of approved add-ons. Add-ons not on the approved list cannot be instantiated or enabled by a user. Preferably, an administrator cannot force a user to use the approved add-ons. Rather, a user preferably retains the power to disable an approved add-on.

Further, an administrator may also disable a user's ability to enable or disable add-ons.

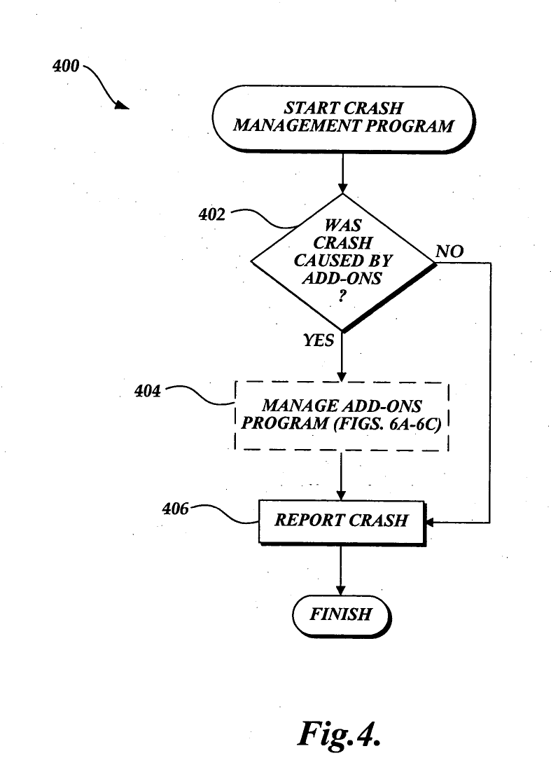

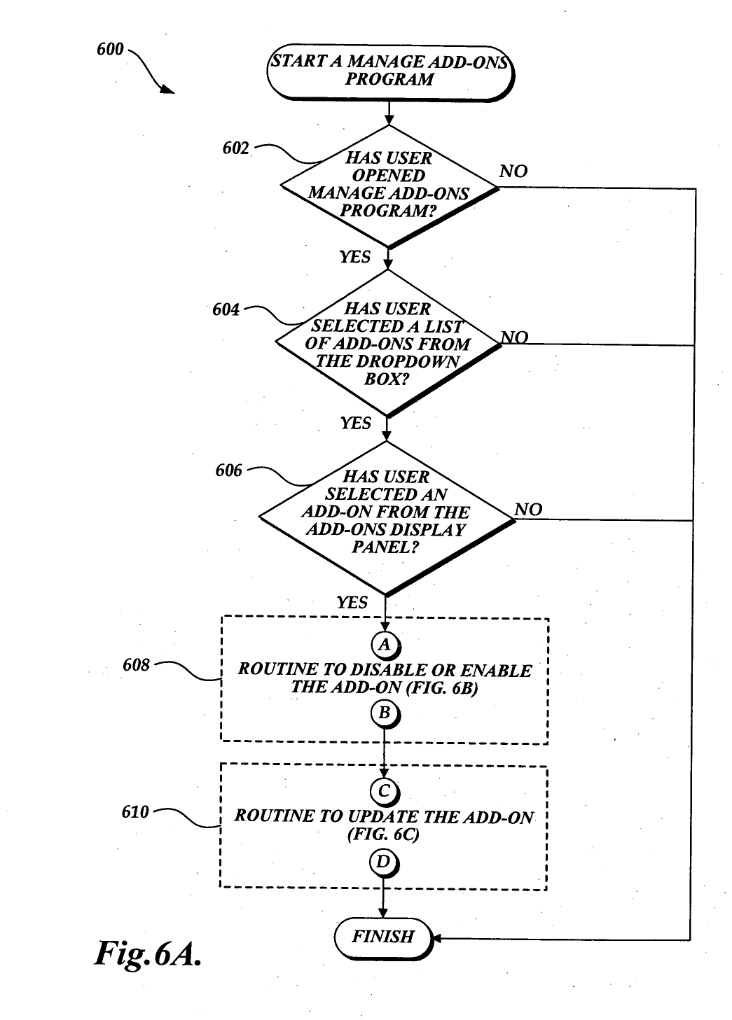

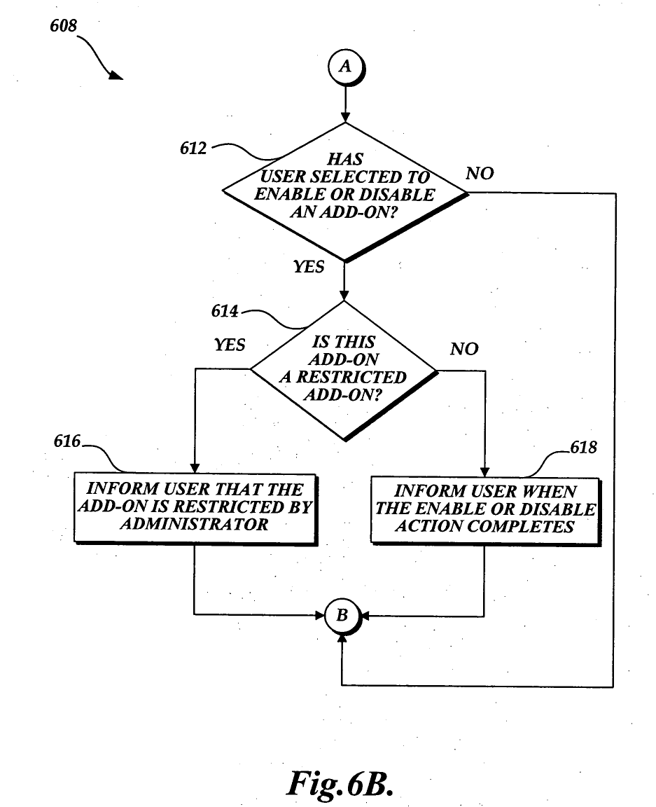

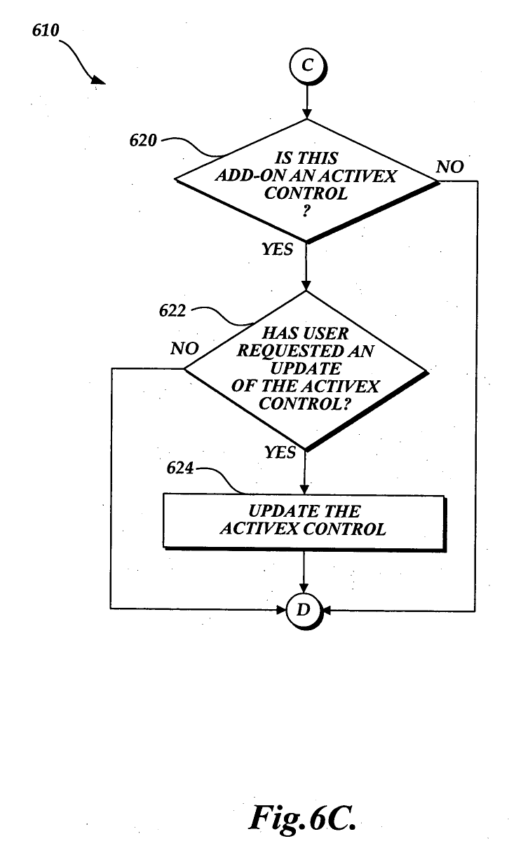

FIG. 4 a functional flow diagram of a method 400 of crash management. The method 400 involves the use of a manage add-ons program 600, as illustrated in FIGS. 6A-6C and described below. When a crash occurs in a Web browser, the method 400 first decides whether the crash was caused by an add-on. See decision block 402. If the answer is NO, the method 400 proceeds to report the crash to the Web browser vendor. If the crash was caused by an add-on, the manage add-ons program 600 is invoked. See block 404. Then, the method 400 proceeds to report the crash to the Web browser vendor. See block 406.

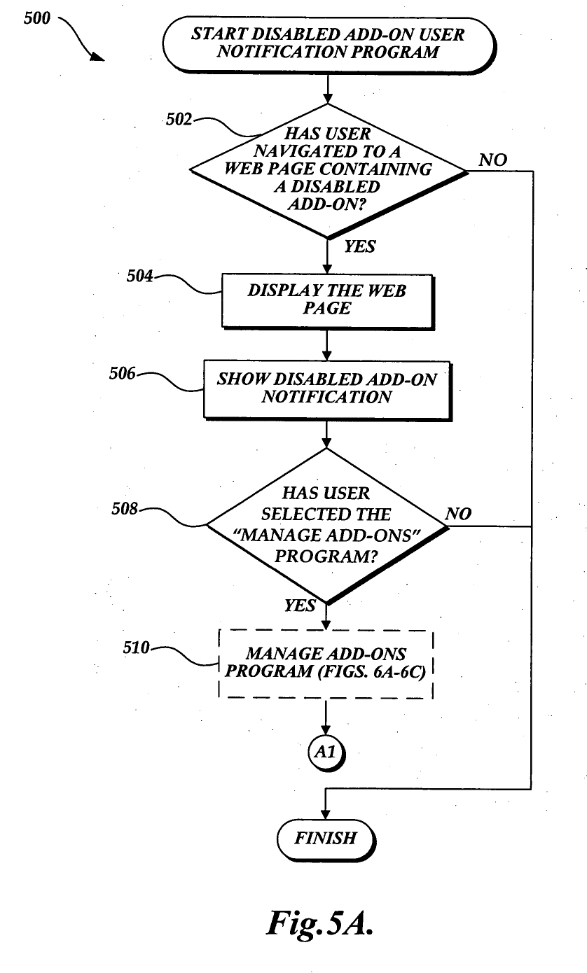

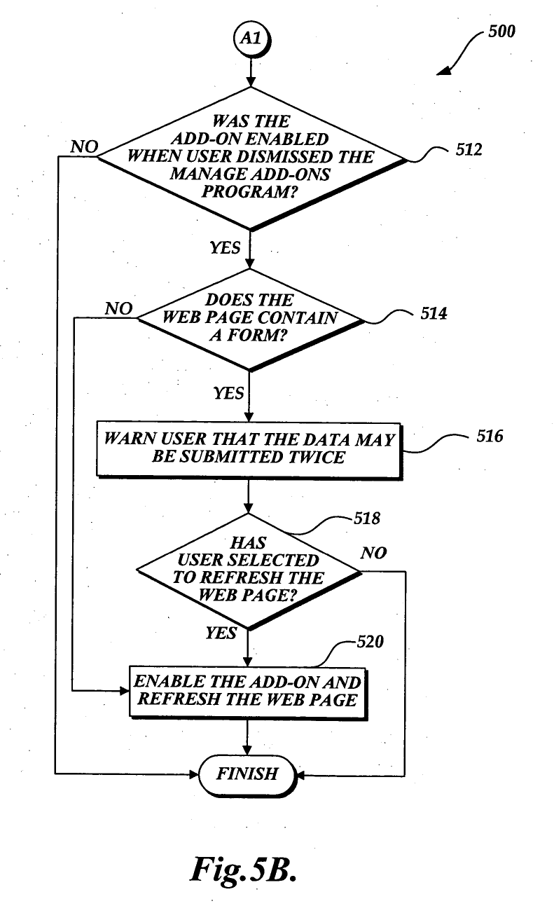

FIGS. 5A and 5B illustrate a method 500 of invoking a manage add-ons program if a user wants to enable a disabled add-on associated with a Web page. The method 500 first checks to see if a user has navigated to a Web page that contains a disabled add-on. See decision block 502. If the answer is NO, the method 500 ends. If the answer is YES, the method 500 displays the Web page associated with the disabled add-on. See block 504. The method 500 also displays a disabled add-on notification, an example of which is illustrated in FIG. 2B. The notification includes a link to a manage add-ons program. The method 500 proceeds to test if the user has selected the link to the manage add-ons program. See decision block 508. If the answer is NO, the method 500 exits. If the answer is YES, the manage add-ons program is invoked. See block 510. The user uses the manage add-ons program to manage the disabled add-on. FIGS. 6A-6C (described below) illustrate a suitable manage add-ons program. The method 500 then proceeds to terminal A1 (FIG. 5B).

From terminal A1 (FIG. 5B), the method 500 proceeds to test whether the disabled add-on was enabled when the user dismissed the manage add-ons program. See decision block 512. If the answer is NO, the method 500 exits. If the answer is YES, the method 500 proceeds to test if the Web page contains a form. See decision block 514. A form is a structured document with predefined areas for entering or changing information. If the Web page does not have a form, the method 500 enables the add-on and refreshes the page. See block 520. The method 500 then exits. If the Web page contains a form, the method 500 proceeds to warn the user that the information in the form may be submitted twice if the user proceeds to refresh the page. See block 516. Double submission of data in a form may induce complications, such as a user's credit card being charged twice if payment information in a form is submitted twice. The method 500 then tests to see if the user has selected to refresh the Web page containing the form. See decision block 518. If the answer is NO, the method 500 exits. If the user decides to refresh the Web page containing the form, the method 500 proceeds to enable the add-on and refresh the Web page. See block 520.

FIGS. 6A-6C comprise an exemplary function flow diagram of a manage add-ons program 600 suitable for use in embodiments of the invention. The manage add-ons program 600 employs a user interface, such as the user interface 300 illustrated in FIG. 3A and described above. First, the manage add-ons program 600 tests whether a user has opened the manage add-ons program. See decision block 602. If the answer is YES, the method 600 proceeds to test whether the user has selected a list of add-ons available in the drop-down box 304. See block 604. If the answer is YES, the method 600 proceeds to test whether the user has selected an add-on from the display panel 312. See decision block 606. If the answer is YES, the method 600 proceeds to a process 608, defined between a continuation terminal A (“terminal A”) and an exit terminal B (“terminal B”). The process 608 provides the steps for disabling or enabling an add-on, according to user preference. FIG. 6B illustrates a suitable process 608. If the answer to any of the tests in the three decisional blocks 602, 604, 606 is NO, the method 600 exits.

From terminal A (FIG. 6B), the process 608 proceeds to test whether the user has selected to either enable or disable an add-on. See decision block 612. If the answer is NO, the process 608 exits through terminal B. If the answer is YES, the process 608 proceeds to test whether this particular add-on is a restricted control. See block 614. This means that this control has been restricted by an administrator, and a user cannot change its status. If this add-on is a restricted control, the process 608 generates a notification that informs the user that the control is restricted by an administrator and suggests that the user to contact the administrator, if necessary. See block 616. An example of such a notification is illustrated in FIG. 3B and described above. The process 608 then proceeds to exit through terminal B. If the control is not a restricted control, the process 608 proceeds to enable or disable the add-on, according to user selection, and informs the user when the action has been completed. See block 618. The process 608 then proceeds to exit through terminal B.

From terminal B (FIG. 6A), the method 600 proceeds to enter a process 610 contained between a continuation terminal C (“terminal C”) and an exit terminal D (“terminal D”). See block 610. The process 610 updates an ActiveX® control if a user decides to do so. FIG. 6C illustrates a suitable process 610.

From terminal C (FIG. 6C), the process 610 proceeds to test whether the add-on is an ActiveX® control. See decision block 620. If the answer is NO, the process 610 proceeds to exit through terminal D. If the answer is YES, meaning this add-on is an ActiveX® control, the process 610 proceeds to test whether the user has requested an update of this particular ActiveX® control. See decision block 622. If the answer is NO, the process 610 proceeds to exit through terminal D. If the user has requested an update to the ActiveX® control, the process 610 then proceeds to update the ActiveX® control. See block 624. The process 610 then exits through terminal D.

From terminal D (FIG. 6A), the method 600 of using a manage add-ons program finishes.

While the preferred embodiment of the invention has been illustrated and described, it will be appreciated that various changes can be made therein without departing from the spirit and scope of the invention as defined by the appended claims.

1. A method of allowing users of an application program to manage add-ons associated with the application program, comprising:
generating a user interface that identifies add-ons associated with an application program and responds to user input for managing the enable/disable state of said add-ons; and
in response to user input, managing the enable/disable state of said add-ons.

2. The method of claim 1, wherein said add-ons are chosen from the group comprising ActiveX® controls, browser helper objects, and toolbar extensions.

3. The method of claim 1, wherein said add-ons include ActiveX® controls, and wherein the method further comprises updating said ActiveX® controls, in response to user input.

4. The method of claim 1, wherein at least some of said add-ons are included in an explicit list of administrator-denied add-ons, and wherein the method further comprises prohibiting the enablement of said administrator-denied add-ons in response to user input.

5. The method of claim 1, wherein at least some of said add-ons are included in an explicit list of administrator-approved add-ons, and wherein the method further comprises allowing the disablement of said administrator-approved add-ons in response to user input.

6. The method of claim 1, wherein an administrator of the application program has the capacity to disable a user's ability to manage the add-ons.

7. The method of claim 1, wherein said user interface identifies add-ons by displaying information selected from the group comprising the name of the add-on, the publisher of the add-on, the status of the add-on, the type of add-on, and the time when the add-on was lastly accessed.

8. The method of claim 1, wherein said user interface includes at least one list of add-ons chosen from the group of lists comprising add-ons that have been used by the application program, add-ons currently loaded for use with the application program, and add-ons currently blocked for use with the application program.

9. A computer-readable medium containing computer-executable instructions for performing steps of a method of allowing users of an application program to manage add-ons associated with the application program, the method comprising:
generating a user interface that identifies add-ons associated with an application program and responds to user input for managing the enable/disable state of said add-ons; and
in response to user input, managing the enable/disable state of said add-ons.

10. The computer-readable medium of claim 9, wherein said add-ons are chosen from the group comprising ActiveX® controls, browser helper objects, and toolbar extensions.

11. The computer-readable medium of claim 9, wherein said add-ons include ActiveX® controls, and wherein the method further comprises updating said ActiveX® controls, in response to user input.

12. The computer-readable medium of claim 9, wherein at least some of said add-ons are included in an explicit list of administrator-denied add-ons, and wherein the method further comprises prohibiting the enablement of said administrator-denied add-ons in response to user input.

13. The computer-readable medium of claim 9, wherein at least some of said add-ons are included in an explicit list of administrator-approved add-ons, and wherein the method further comprises allowing the disablement of said administrator-approved add-ons in response to user input.

14. The computer-readable medium of claim 9, wherein an administrator of the application program has the capacity to disable a user's ability to manage the add-ons.

15. The computer-readable medium of claim 9, wherein said user interface identifies add-ons by displaying information selected from the group comprising the name of the add-on, the publisher of the add-on, the status of the add-on, the type of add-on, and the time when the add-on was lastly accessed.

16. The computer-readable medium of claim 9, wherein said user interface includes at least one list of add-ons chosen from the group of lists comprising add-ons that have been used by the application program, add-ons currently loaded for use with the application program, and add-ons currently blocked for use with the application program.
